(19) United States
(12) Patent Application Publication
(10) Pub. No.: US 2019/0277043 A1
(43) Pub. Date: Sep. 12, 2019

(54) WORK PLATFORM COMPRISING A CRANE DEVICE

(71) Applicant: UPCLIMBER APS, København SV (DK)

(72) Inventors: Andreas LOLLE, København (DK); Steffen NIELSEN OSTERBERG, København (DK)

(21) Appl. No.: 16/334,959

(22) PCT Filed: Sep. 11, 2017
(86) PCT No.: PCT/DK2017/000014

§ 371 Date: Mar. 20, 2019

(30) Foreign Application Priority Data
Sep. 22, 2016 (DK) PA201600557

(51) Int. Cl. E04G 5/00; E04G 1/18; B66C 23/16

(52) U.S. Cl. CPC E04G 5/00; E04G 1/24; B66C 23/166; E04G 1/18

(57) ABSTRACT

Work platform, comprising an elevatable platform deck provided with a rail system having one or more rails extending in a longitudinal direction along a trailing edge of the deck; a trolley engaging with the one or more rails and configured for being moved in the longitudinal direction; and a crane device mounted on the trolley, configured for lifting and moving objects above the platform surface.

### FIELD OF THE INVENTION

The present invention relates to a work platform comprising an elevatable platform deck and a crane device for lifting and moving objects above the platform deck.

### BACKGROUND OF THE INVENTION

Work platforms, such as mast climbing platform or construction lifting platform are known in many variations and widely used as an alternative to traditional scaffolding equipment. Work platforms may be modular system comprising one or more columns or masts and platform decks of varying length tailored to specific requirements. In operation the platform deck is supported by the one or more columns and may be elevated to the desired height providing optimal working conditions. Further, by positioning the platform deck close to the ground, building materials may be easily loaded onto the platform deck using a forklift. Subsequently, the platform deck may be used to lift building materials to the installation site. Such a platform included in a multifunctional basket is known from the international patent application, WO 2010/118481 A2, disclosing an extendable platform provided with a centered fixed crane. Other known work platforms often comprise a so-called top crane mounted onto the top of the column supporting the platform. Such a crane may be used to position building materials already arranged on the platform deck or assist in the final installation of for example windows. However, such top cranes experience several drawbacks such as limited operation range and time-consuming installation. If the platform comprises several columns, more cranes are needed to cover the entire platform. Additionally, if it is necessary to move the platform, the top crane must be dismantled before the platform can be moved, and subsequently reinstalled. Further, when the platform is position close to the ground, the lifting wire extends all the way from the top of the column, creating difficult lifting conditions.

### OBJECT OF THE INVENTION

An object of the present invention is to wholly or partly overcome the above disadvantages and drawbacks of the prior art. More specifically, it is an object to provide work platform comprising a flexible system for lifting and moving objects, such as building material.

### SUMMARY OF THE INVENTION

Thus, the above described object and several other objects are intended to be obtained in a first aspect of the invention by providing a work platform for performing construction work, comprising an elevatable platform deck having a substantial planar platform surface extending between a leading edge and a trailing edge; characterized in that the work platform further comprises: a rail system having one or more rails extending in a longitudinal direction along the trailing edge of the platform deck; a trolley engaging with the one or more rails and configured for being moved in the longitudinal direction along the rails; and a crane device mounted on the trolley, configured for lifting and moving objects above the platform surface.

Hereby the work platform is provided with a flexible lifting system configured for lifting and moving objects. By moving the trolley and the associated crane device in the longitudinal direction, object may be lifted and positioned along the entire length of the platform.

Further, the above mentioned work platform may comprise a crane device comprises a vertical pillar mounted on the trolley; and a horizontal jib displaceable arranged on the vertical pillar, and configured for providing an operating arm displaceable between a retracted position and an extended position. Hereby the flexibility of the lifting system is further improved as the operating arm may be displaced in a transversal direction along the width of the platform combined with the trolley being movable along the length of the platform.

These and other aspects of the invention will be apparent from and elucidated with reference to the embodiments described hereinafter.

### BRIEF DESCRIPTION OF THE FIGURES

The work platform according to the invention will now be described in more detail with regard to the accompanying figures. The figures show one way of implementing the present invention and is not to be construed as being limiting to other possible embodiments falling within the scope of the attached claim set.

FIG. 1 shows a work platform comprising an elevatable platform deck seen from the back,

FIG. 2A shows an isomeric view of the work platform of FIG. 1,

FIG. 2B shows an enlarged view of the work platform within area A indicated in FIG. 2A,

FIG. 3 shows a crane device,

FIG. 4 shows cross-section of the platform deck illustrating rail brackets, rails, and the trolley, and

FIG. 5 shows a work platform provided with an alternative hoist.

### DETAILED DESCRIPTION OF AN EMBODIMENT

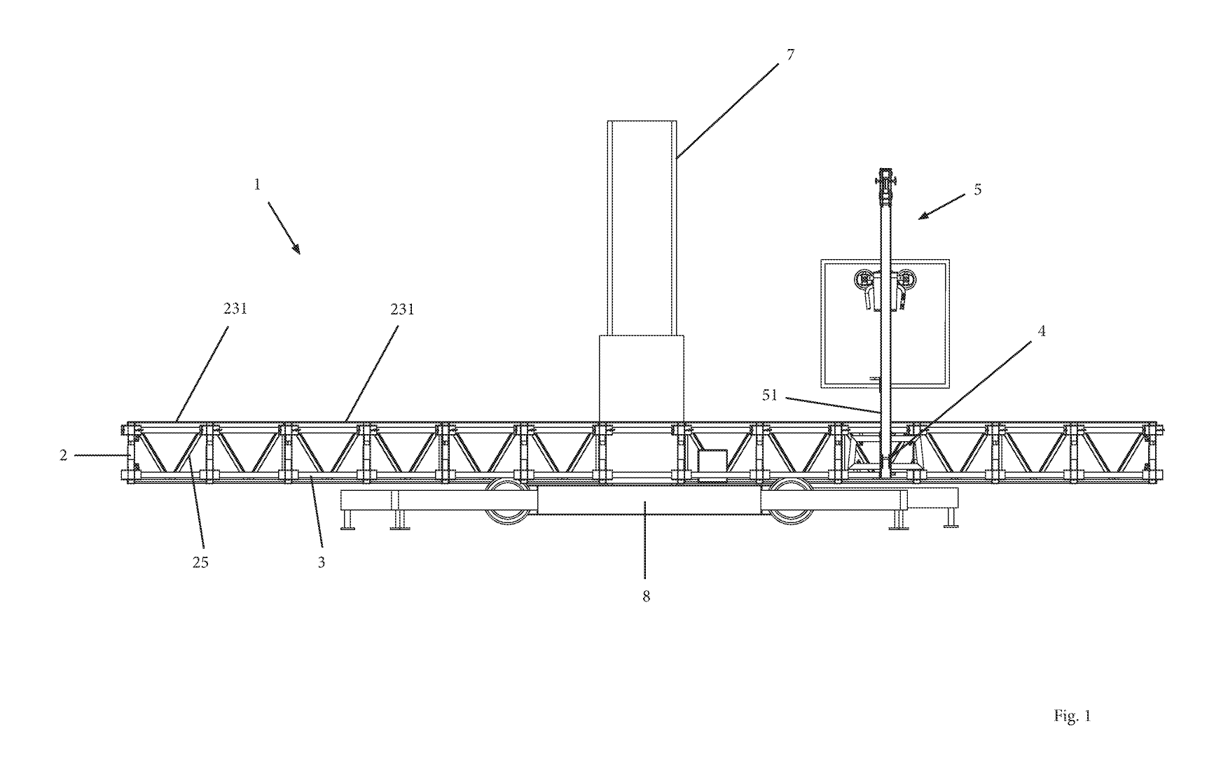

Referring to FIG. 1, the work platform 1 according to one embodiment of the invention comprises an elevatable platform deck 2 mounted on a mast 7. The mast is positioned on a base 8 supporting the entire work platform. To elevate the platform deck 2 from the position shown in the figure, the platform deck is moved along the mast by means known to the skilled person. In other embodiments not further described, the work platform may comprise more than one mast for supporting the elevatable platform deck.

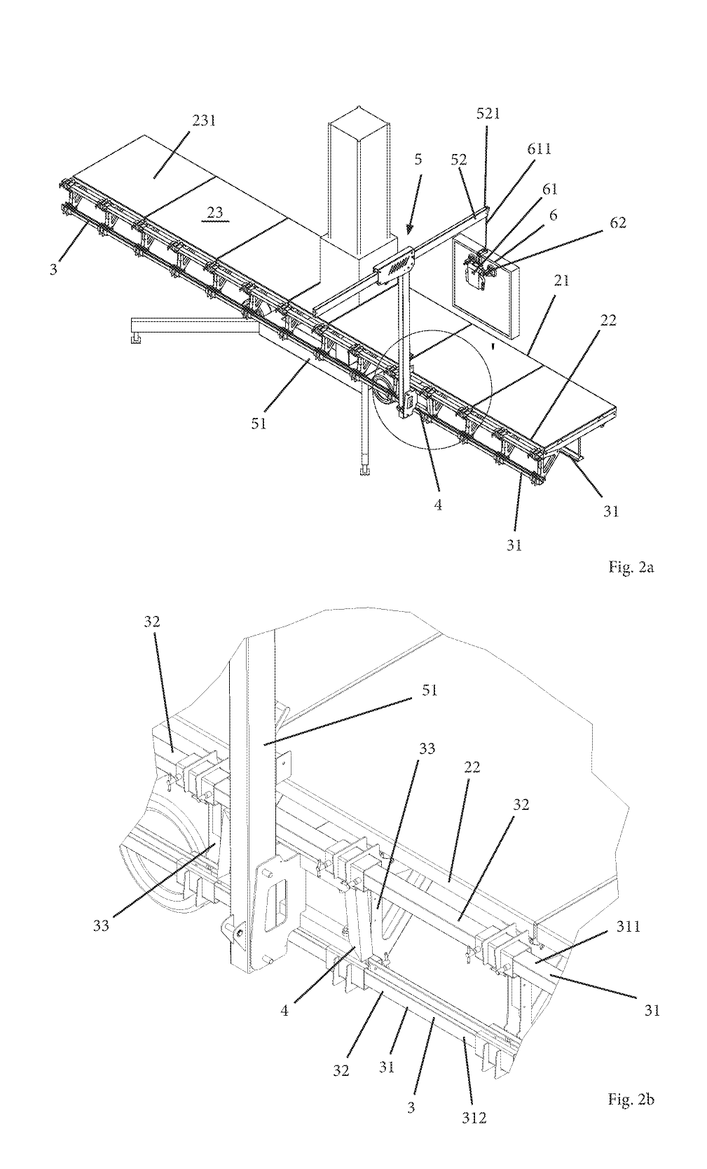

As seen from FIG. 2A the platform deck has a substantial planar platform surface 23 extending between a leading edge 21 and a trailing edge 22. In operation, the leading edge faces against the working area, such as the facade of a building, and the trailing edge face away from the working area. When the platform deck is in the lower position, as shown in FIG. 1 and FIG. 2A, building material and the like may be loaded onto the platform from the trailing edge.

Additionally, as seen form FIG. 2A, the platform deck 2 is constituted by a plurality of deck sections 231. The deck sections are supported by a frame construction 25, which may be extended according to the number of deck sections needed to provide a platform deck of the desired length. The platform deck is thus a modular construction that can be easily adapted to meet specific requirements.

As seen from FIGS. 2A and 2B, the work platform further comprises a rail system 3 comprising a top rail 31, 311 and a bottom rail 31, 312 extending in a longitudinal direction along the trailing edge. Further, a trolley 4 engaging with the top- and bottom rails are provided and a crane device 5 is mounted on the trolley. The trolley 4 is configured for being moved in the longitudinal direction along the length of the platform deck, whereby also the crane device is movable in the longitudinal direction.

The top- and bottom rails are mounted to the platform deck by a plurality of rail brackets 33 extending from underneath the platform surface. Hereby the rails are supported along the entire length of the work platform. Further, as best seen from FIG. 2B, in one embodiment the trolley 4 has a length corresponding to a length between the rail brackets 33. Hereby, the trolley is usually supported by more than one rail brackets and forces induced by the crane on the trolley are distributed more evenly throughout the platform deck.

Referring to FIG. 2B, each rail 31, 311, 312 is constituted by a plurality of rails segments 32 arranged one after the other. The rail segments 32 are joined inside the rail bracket 33, whereby proper alignment is secured and a continuous rail is provided.

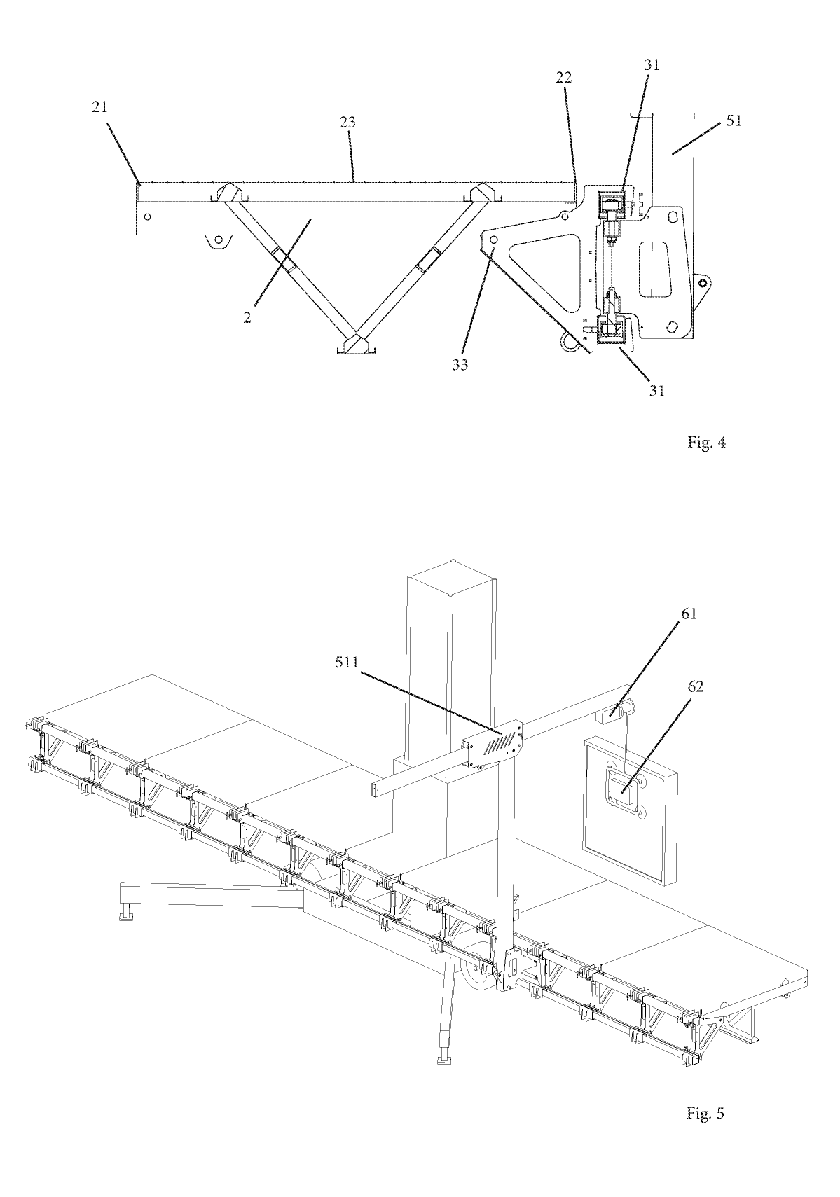

Additionally, in one embodiment the top rail 311 of the rail system is positioned in flush with or below the platform surface as seen from FIG. 4. By arranging the rail system 3 such that the upper most part of the rail and/or rail bracket is below the platform surface, unrestricted access to the platform deck is achieved. Hereby, for example building material on pallets may be easily loaded onto the platform using a forklift, without the risk of damaging the rail system.

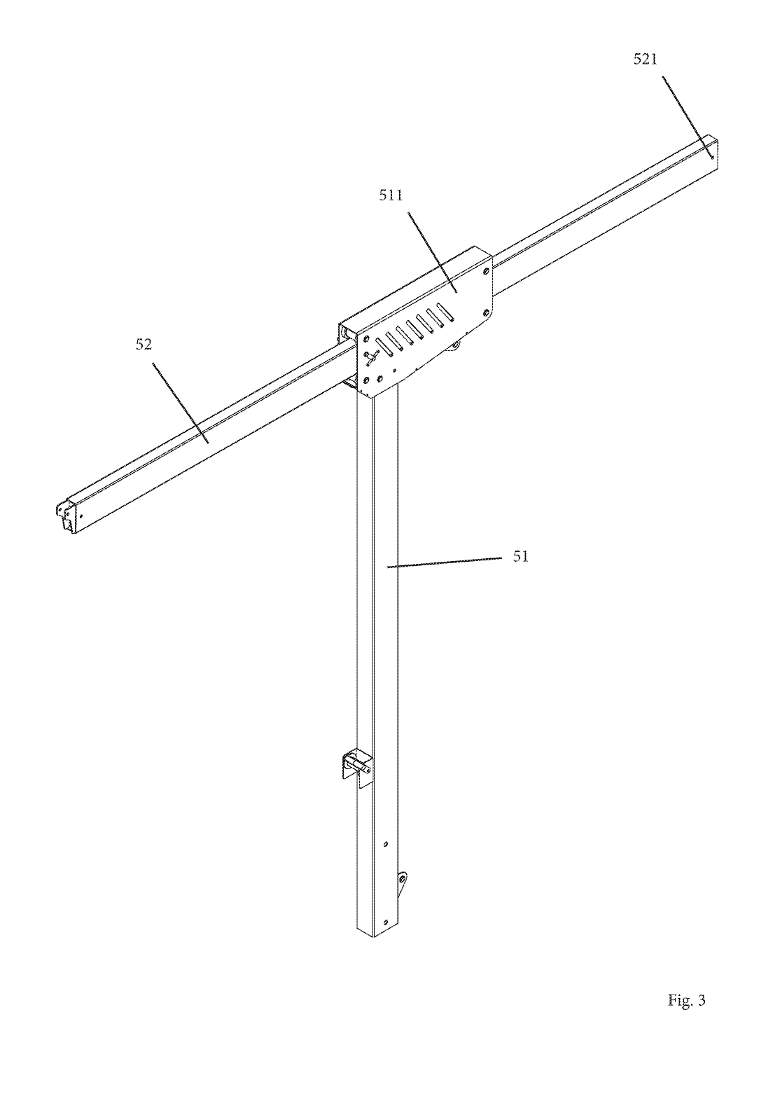

Referring to FIG. 3, the crane device comprises a vertical pillar 51 configured for being mounted on the trolley as shown in FIG. 4. The crane device further comprises a horizontal jib 52 displaceably arranged on the vertical pillar and configured for providing an operating arm. The jib is displaceable between a retracted position (not shown) and an extended position as shown in FIG. 2A. In the extended position a distal end 521 of the jib is arranged above the leading edge of the platform deck. Whereas, in the retracted position the distal end 521 is positioned adjacent the vertical pillar. Hereby the crane device and any objects lifted by the crane may be moved along the length of the platform deck passing behind the one or more masts 7 supporting the platform deck.

The horizontal jib is arranged in a jib guide 511 mounted on the vertical pillar, such as at the top of the vertical pillar as shown in FIG. 3. The jib guide 511 includes a plurality of rollers supporting the jib and allowing the transversal jib displacement. In one embodiment the jib guide may be provided with actuation means, such as an electrical motor, for moving the jib back and forth. Similar, the trolley 4 supporting the vertical pillar of the crane device, may be provided with a trolley motor or other actuation means for moving the trolley along the platform deck 2. Providing a motorized trolley and/or jib guide also enables remote controlling of crane movements, which may be advantageous in some work scenarios.

As seen from FIG. 2A, the crane device may further be provided with a hoist device 6 suspended from the distal end 521 of the jib. The shown hoist device comprises a motorized winch 61 provided with a lifting wire 611 attached to the jib. The hoist device further comprises a lifting device 62, such as a lifting beam, for securing objects to the hoist device. As envisaged by the skilled person, other hoisting means may be used in combination with the crane device without departing from the scope of the invention. For example, FIG. 5 shows a crane device provided with a motorized winch 61 and lifting wire 611 arranged at the distal end 521 of the horizontal jib 52. At the end of lifting wire a lifting device 62 is arranged for securing objects to the hoist

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A work platform, comprising an elevatable platform deck having a substantial planar platform surface extending between a leading edge and a trailing edge; characterized in that the work platform further comprises:
a rail system having one or more rails extending in a longitudinal direction along the trailing edge;
a trolley engaging with the one or more rails and configured for being moved in the longitudinal direction; and
a crane device mounted on the trolley, configured for lifting and moving objects above the platform surface.

2. The work platform according to claim 1, wherein the crane device comprises a vertical pillar mounted on the trolley; and
a horizontal jib displaceably arranged on the vertical pillar, configured for providing an operating arm displaceable between a retracted position and an extended position.

3. The work platform according to claim 2, wherein the crane device is provided with a hoist device suspended from a distal end of the jib, the hoist device comprising a motorized winch provided with a wire attached to the distal end of the jib and a lifting device, such as a lifting beam, for securing objects to the hoist device.

4. The work platform according to claim 1, wherein the rail system comprises a plurality of rail brackets mounted on the elevatable platform deck, the rail brackets being adapted to receive the one or more rails extending in the longitudinal direction.

5. The work platform according to claim 4, wherein the rail system comprises a top rail and a bottom rail arranged below the top rail, and corresponding wheels of the trolley are configured for engaging with top and bottom rails.

6. The work platform according to claim 4, wherein each rail is constituted by a plurality of rails segments arranged in a continuous manner and mutually joined by the rail brackets.

7. The work platform according to claim 5, wherein the top rail of the rail system is positioned flush with or below the platform surface thereby enabling unrestricted access to the platform deck.

8. The work platform according to claim 5, wherein each rail is constituted by a plurality of rails segments arranged in a continuous manner and mutually joined by the rail brackets.

9. The work platform according to claim 6, wherein the top rail of the rail system is positioned flush with or below the platform surface thereby enabling unrestricted access to the platform deck.
